(19) United States
(12) Patent Application Publication
(10) Pub. No.: US 2020/0077425 A1
(43) Pub. Date: Mar. 5, 2020

(54) INTELLIGENT SCHEDULING OF A WIRELESS NETWORK FOR A BACKHAUL

(71) Applicant: Cisco Technology, Inc., San Jose, CA (US)

(72) Inventors: Matthew Aaron Silverman, Shaker Heights, OH (US); Qing Zhao, Fremont, CA (US); John T. Chapman, Orange, CA (US); Dantong Liu, Mountain View, CA (US)

(21) Appl. No.: 16/115,506

(22) Filed: Aug. 28, 2018

(51) Int. Cl. H04W 72/12; H04W 72/14; G06F 15/18

(52) U.S. Cl. CPC H04W 72/1268; H04W 72/14; H04L 12/2801; G06F 15/18; H04W 72/1273

(57) ABSTRACT

Systems, methods, and computer-readable media for coordinating scheduling between a wireless scheduler and a backhaul scheduler to reduce uplink data transmission latency. In some examples, an uplink data prediction for uplink data to transmit over a wireless connection of a wireless network is identified by a wireless scheduler of a wireless network. The uplink data prediction can be provided to a backhaul scheduler of a backhaul of the wireless network. The wireless scheduler can be coordinated with the backhaul scheduler by the backhaul scheduler to coordinate transmission of the uplink data through the backhaul based on the uplink data prediction. The uplink data can then be received at the backhaul for transmission through the backhaul based on the uplink data prediction.

### TECHNICAL FIELD

The present technology pertains to reducing uplink latency in a network formed by a wireless network and a backhaul, and in particular to coordinating a wireless scheduler of the wireless network with a backhaul scheduler of the backhaul to reduce uplink latency in the wireless network and the backhaul.

### BACKGROUND

Uplink latency in a network including a wireless network and a backhaul can be hindered by latency in the backhaul. Uplink latency, as used herein, refers to latency in transmitting uplink data through the wireless portion of the wireless network and the backhaul towards a core of the network. Specifically, a wireless networking device, e.g. access point, can receive data over a wireless connection of the wireless network. However, due to latency in the backhaul of the wireless network, transmission of the data, e.g. as uplink data, through the backhaul can ultimately be delayed. In turn, this can increase overall latency in the network. There therefore exist needs for systems and methods for reducing uplink latency in a wireless network and a corresponding backhaul. Specifically, there exist needs for coordinating a scheduler of the wireless network with a scheduler of the backhaul to reduce uplink latency in the network.

Mobile-aware scheduling for backhauls, e.g. backhauls with low latency, has already been proposed to improve the uplink user equipment-to-mobile core latency by coordinating the Long-Term Evolution (herein referred to as “LTE”) and Data Over Cable Service Interface Specifications (herein referred to as “DOCSIS”) scheduling operations. DOCSIS is a commonly used scheduling mechanism for Wi-Fi backhauls, especially for residential and small or medium-sized business cases. From a Wi-Fi wireless network perspective, scheduled transmission is first introduced in IEEE 802.11ax. However, mechanisms have not been developed for coordinating DOCSIS schedulers with 802.11ax schedulers. In particular, 802.11ax based wireless networks can still experience overall latency issues due to latency in network backhauls of the Wi-Fi networks. Specifically, the timing and operations of 802.11ax schedulers is different from the timing and operations of DOCSIS schedulers. There therefore exist needs for systems and methods for coordinating the 802.11ax and DOCSIS schedulers to reduce the overall uplink system latency.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example cloud computing architecture;

FIG. 1B illustrates an example fog computing architecture;

FIG. 2A illustrates a diagram of an example network environment, such as a data center;

FIG. 2B illustrates another example of a network environment;

FIG. 3 illustrates an example wireless communication network in which some aspects of the technology can be implemented;

FIG. 4 is a wireless network environment and a corresponding communication timing diagram for coordinating schedulers between a wireless network and a backhaul network;

FIG. 5 illustrates a flowchart for an example method of coordinating a wireless scheduler and a backhaul scheduler in a wireless network to decrease uplink latency;

FIG. 6 illustrates an example computing system; and

FIG. 7 illustrates an example network device.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

A method can include identifying, by a wireless scheduler of a wireless network, an uplink data prediction for uplink data to transmit over a wireless connection of the wireless network. The uplink data prediction can be provided to a backhaul scheduler of a backhaul of the wireless network. The wireless scheduler can be coordinated with the backhaul scheduler to coordinate transmission of the uplink data through the backhaul based on the uplink data prediction. Further, the uplink data can be received at the backhaul for transmission through the backhaul based on the uplink data prediction.

A system can include a wireless scheduler of a wireless network for identifying an uplink data prediction for uplink data to transmit over a wireless connection of the wireless network. The system can provide the uplink data prediction to the backhaul scheduler of a backhaul of the wireless network. Further, the system can coordinate the wireless scheduler with the backhaul scheduler by configuring the backhaul scheduler to coordinate transmission of the uplink data through the backhaul based on the uplink data prediction.

A system can include a wireless scheduler of an 802.11ax compliant wireless network for identifying an uplink data prediction for uplink data to transmit over a wireless connection of the wireless network. The system can provide the uplink data prediction to the backhaul scheduler of a backhaul of the wireless network. Further, the system can coordinate the wireless scheduler with the backhaul scheduler by configuring the backhaul scheduler to coordinate transmission of the uplink data through the backhaul based on the uplink data prediction. Subsequently, the backhaul can receive the uplink data for transmission through the backhaul based on the uplink data prediction.

### Description

The disclosed technology addresses the need in the art for reducing uplink latency in a network formed by a wireless network and a backhaul with high latency. The present technology involves system, methods, and computer-readable media for coordinating a wireless scheduler of a wireless network with a backhaul scheduler of a backhaul to reduce uplink latency in the wireless network and the backhaul.

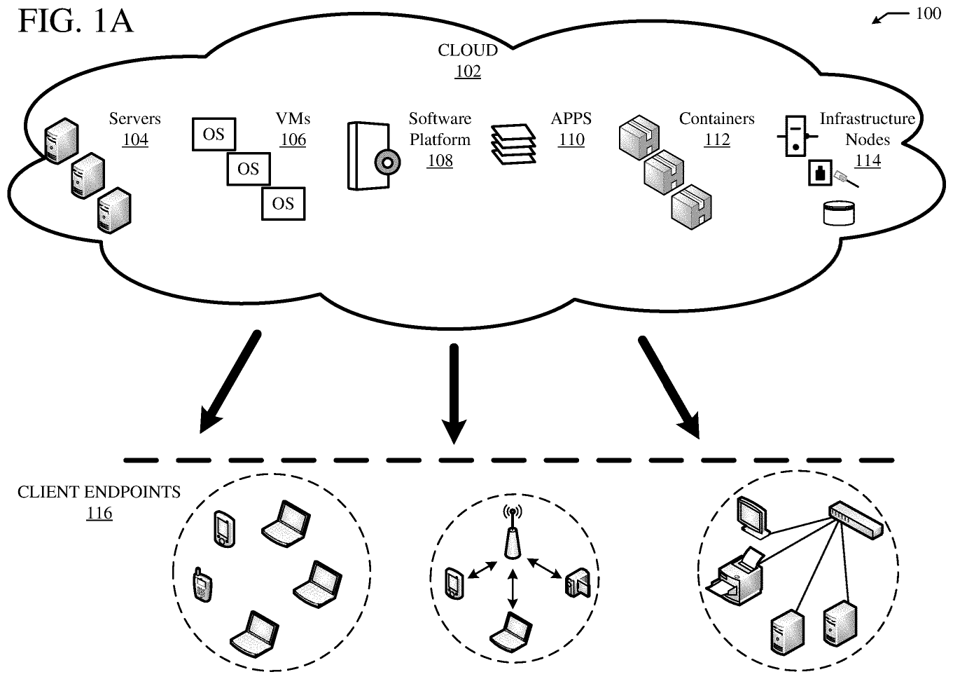

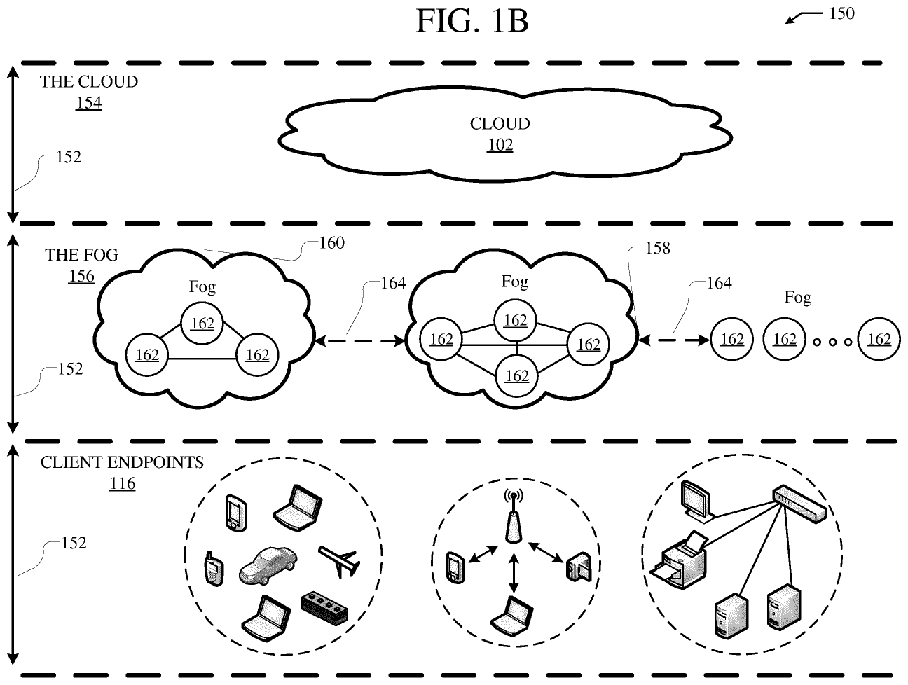

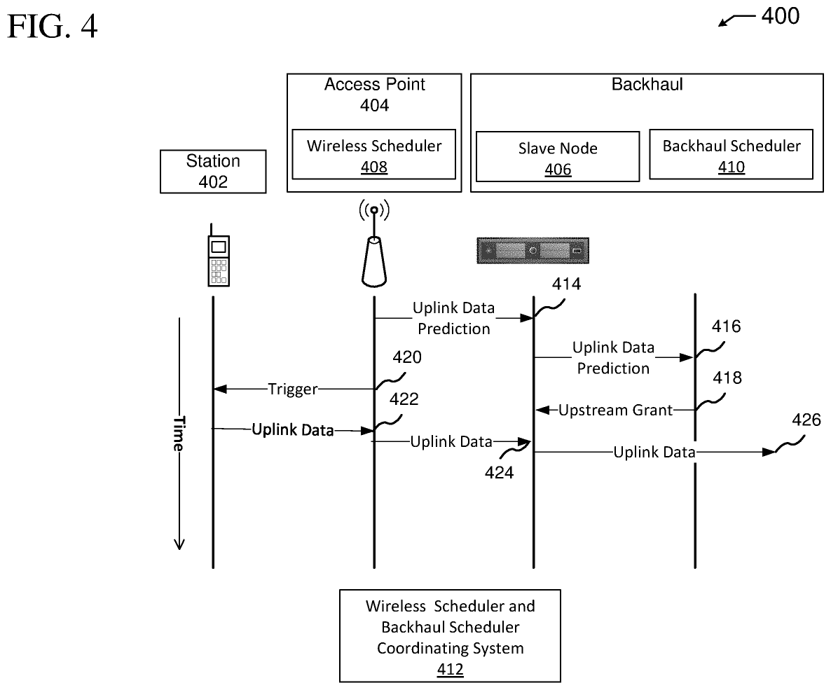

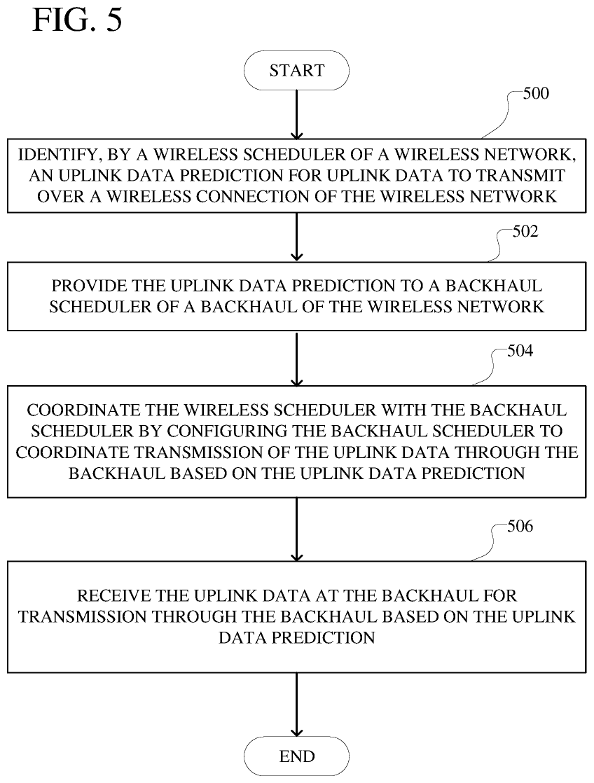

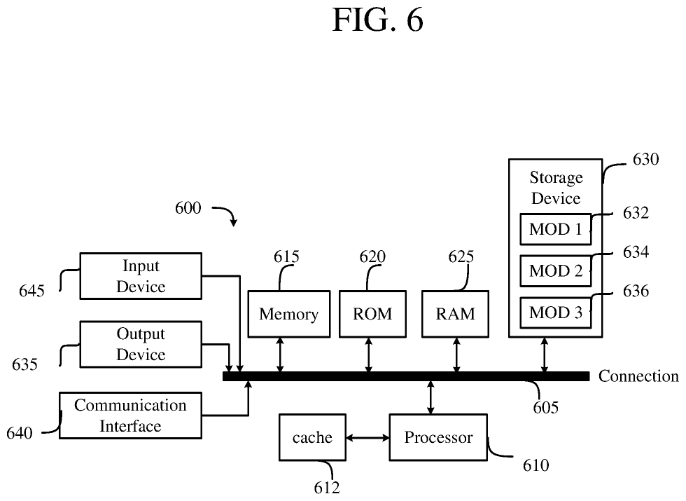

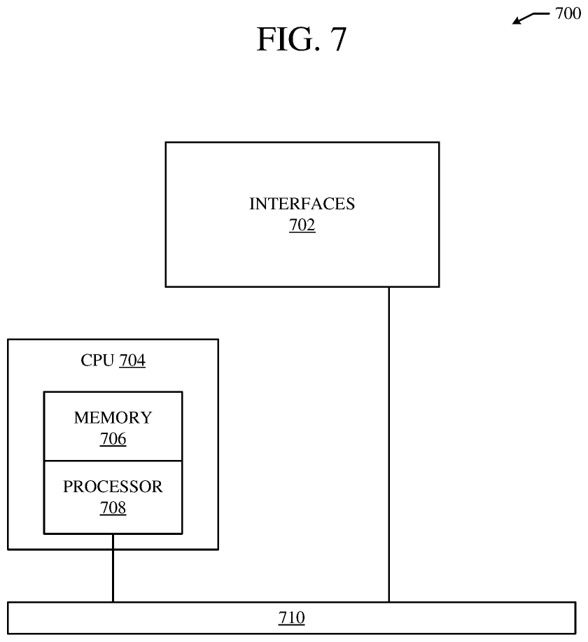

A description of network environments and architectures for network data access and services, as illustrated in FIGS. 1A, 1B, 2A, 2B, and 3 is first disclosed herein. A discussion of systems and methods for coordinating a wireless scheduler and a backhaul scheduler for transmitting uplink data to reduce uplink latency, as shown in FIGS. 4 and 5, will then follow. The discussion then concludes with a brief description of example devices, as illustrated in FIGS. 6 and 7. These variations shall be described herein as the various embodiments are set forth. The disclosure now turns to FIG. 1A.

FIG. 1A illustrates a diagram of an example cloud computing architecture 100. The architecture can include a cloud 102. The cloud computing architecture 100 can be used to transmit uplink data or otherwise receive uplink data from a wireless network. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture 150. The fog computing architecture 150 can include the cloud layer 154, which includes the cloud 102 and any other cloud system or environment, and the fog layer 156, which includes fog nodes 162. The fog computing architecture 150 can form part of a wireless network and used to transmit uplink data, e.g. to a core of a network. Alternatively, the fog computing architecture 150 can receive uplink data from a wireless network and used to transmit the uplink data, e.g. to a core of a network. The client endpoints 116 can communicate with the cloud layer 154 and/or the fog layer 156. The architecture 150 can include one or more communication links 152 between the cloud layer 154, the fog layer 156, and the client endpoints 116. Communications can flow up to the cloud layer 154 and/or down to the client endpoints 116.

The fog layer 156 or “the fog” provides the computation, storage and networking capabilities of traditional cloud networks, but closer to the endpoints. The fog can thus extend the cloud 102 to be closer to the client endpoints 116. The fog nodes 162 can be the physical implementation of fog networks. Moreover, the fog nodes 162 can provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. The fog instances 158, 158 can be local or regional clouds or networks. For example, the fog instances 156, 158 can be a regional cloud or data center, a local area network, a network of fog nodes 162, etc. In some configurations, one or more fog nodes 162 can be deployed within a network, or as standalone or individual nodes, for example. Moreover, one or more of the fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographic locations, logical locations or networks, and/or fog instances while maintaining connectivity with the cloud layer 154 and/or the endpoints 116. For example, a particular fog node can be placed in a vehicle, such as an aircraft or train, which can travel from one geographic location and/or logical location to a different geographic location and/or logical location. In this example, the particular fog node may connect to a particular physical and/or logical connection point with the cloud 154 while located at the starting location and switch to a different physical and/or logical connection point with the cloud 154 while located at the destination location. The particular fog node can thus move within particular clouds and/or fog instances and, therefore, serve endpoints from different locations at different times.

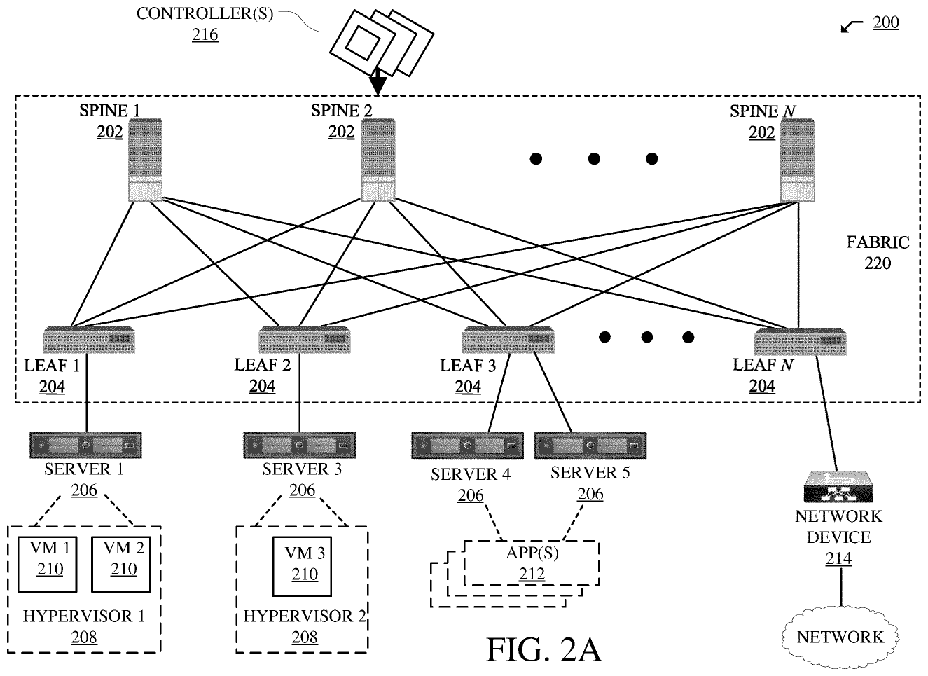

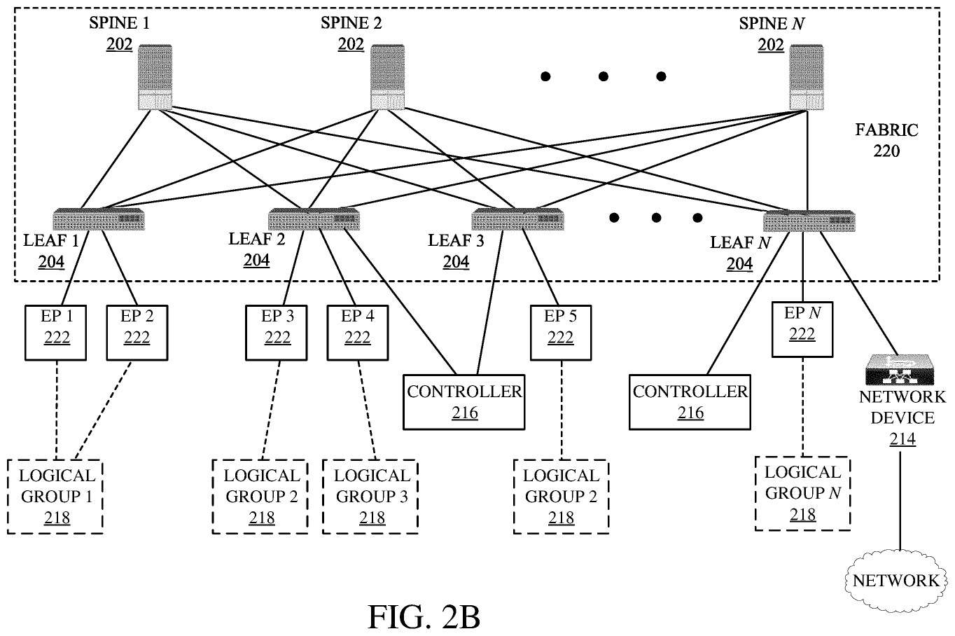

FIG. 2A illustrates a diagram of an example Network Environment 200, such as a data center. The Network Environment 200 can be used transmit uplink data as part of a wireless network or uplink data that is received from the wireless network. In some cases, the Network Environment 200 can include a data center, which can support and/or host the cloud 102. The Network Environment 200 can include a Fabric 220 which can represent the physical layer or infrastructure (e.g., underlay) of the Network Environment 200. Fabric 220 can include Spines 202 (e.g., spine routers or switches) and Leafs 204 (e.g., leaf routers or switches) which can be interconnected for routing or switching traffic in the Fabric 220. Spines 202 can interconnect Leafs 204 in the Fabric 220, and Leafs 204 can connect the Fabric 220 to an overlay or logical portion of the Network Environment 200, which can include application services, servers, virtual machines, containers, endpoints, etc. Thus, network connectivity in the Fabric 220 can flow from Spines 202 to Leafs 204, and vice versa. The interconnections between Leafs 204 and Spines 202 can be redundant (e.g., multiple interconnections) to avoid a failure in routing. In some embodiments, Leafs 204 and Spines 202 can be fully connected, such that any given Leaf is connected to each of the Spines 202, and any given Spine is connected to each of the Leafs 204. Leafs 204 can be, for example, top-of-rack (“ToR”) switches, aggregation switches, gateways, ingress and/or egress switches, provider edge devices, and/or any other type of routing or switching device.

Leafs 204 can be responsible for routing and/or bridging tenant or customer packets and applying network policies or rules. Network policies and rules can be driven by one or more Controllers 216, and/or implemented or enforced by one or more devices, such as Leafs 204. Leafs 204 can connect other elements to the Fabric 220. For example, Leafs 204 can connect Servers 206, Hypervisors 208, Virtual Machines (VMs) 210, Applications 212, Network Device 214, etc., with Fabric 220. Such elements can reside in one or more logical or virtual layers or networks, such as an overlay network. In some cases, Leafs 204 can encapsulate and decapsulate packets to and from such elements (e.g., Servers 206) in order to enable communications throughout Network Environment 200 and Fabric 220. Leafs 204 can also provide any other devices, services, tenants, or workloads with access to Fabric 220. In some cases, Servers 206 connected to Leafs 204 can similarly encapsulate and decapsulate packets to and from Leafs 204. For example, Servers 206 can include one or more virtual switches or routers or tunnel endpoints for tunneling packets between an overlay or logical layer hosted by, or connected to, Servers 206 and an underlay layer represented by Fabric 220 and accessed via Leafs 204.

Applications 212 can include software applications, services, containers, appliances, functions, service chains, etc. For example, Applications 212 can include a firewall, a database, a CDN server, an IDS/IPS, a deep packet inspection service, a message router, a virtual switch, etc. An application from Applications 212 can be distributed, chained, or hosted by multiple endpoints (e.g., Servers 206, VMs 210, etc.), or may run or execute entirely from a single endpoint.

VMs 210 can be virtual machines hosted by Hypervisors 208 or virtual machine managers running on Servers 206. VMs 210 can include workloads running on a guest operating system on a respective server. Hypervisors 208 can provide a layer of software, firmware, and/or hardware that creates, manages, and/or runs the VMs 210. Hypervisors 208 can allow VMs 210 to share hardware resources on Servers 206, and the hardware resources on Servers 206 to appear as multiple, separate hardware platforms. Moreover, Hypervisors 208 on Servers 206 can host one or more VMs 210.

In some cases, VMs 210 and/or Hypervisors 208 can be migrated to other Servers 206. Servers 206 can similarly be migrated to other locations in Network Environment 200. For example, a server connected to a specific leaf can be changed to connect to a different or additional leaf. Such configuration or deployment changes can involve modifications to settings, configurations and policies that are applied to the resources being migrated as well as other network components.

In some cases, one or more Servers 206, Hypervisors 208, and/or VMs 210 can represent or reside in a tenant or customer space. Tenant space can include workloads, services, applications, devices, networks, and/or resources that are associated with one or more clients or subscribers. Accordingly, traffic in Network Environment 200 can be routed based on specific tenant policies, spaces, agreements, configurations, etc. Moreover, addressing can vary between one or more tenants. In some configurations, tenant spaces can be divided into logical segments and/or networks and separated from logical segments and/or networks associated with other tenants. Addressing, policy, security and configuration information between tenants can be managed by Controllers 216, Servers 206, Leafs 204, etc.

Configurations in Network Environment 200 can be implemented at a logical level, a hardware level (e.g., physical), and/or both. For example, configurations can be implemented at a logical and/or hardware level based on endpoint or resource attributes, such as endpoint types and/or application groups or profiles, through a software-defined network (SDN) framework (e.g., Application-Centric Infrastructure (ACI) or VMWARE NSX). To illustrate, one or more administrators can define configurations at a logical level (e.g., application or software level) through Controllers 216, which can implement or propagate such configurations through Network Environment 200. In some examples, Controllers 216 can be Application Policy Infrastructure Controllers (APICs) in an ACI framework. In other examples, Controllers 216 can be one or more management components for associated with other SDN solutions, such as NSX Managers.

Such configurations can define rules, policies, priorities, protocols, attributes, objects, etc., for routing and/or classifying traffic in Network Environment 200. For example, such configurations can define attributes and objects for classifying and processing traffic based on Endpoint Groups (EPGs), Security Groups (SGs), VM types, bridge domains (BDs), virtual routing and forwarding instances (VRFs), tenants, priorities, firewall rules, etc. Other example network objects and configurations are further described below. Traffic policies and rules can be enforced based on tags, attributes, or other characteristics of the traffic, such as protocols associated with the traffic, EPGs associated with the traffic, SGs associated with the traffic, network address information associated with the traffic, etc. Such policies and rules can be enforced by one or more elements in Network Environment 200, such as Leafs 204, Servers 206, Hypervisors 208, Controllers 216, etc. As previously explained, Network Environment 200 can be configured according to one or more particular software-defined network (SDN) solutions, such as CISCO ACI or VMWARE NSX. These example SDN solutions are briefly described below.

ACI can provide an application-centric or policy-based solution through scalable distributed enforcement. ACI supports integration of physical and virtual environments under a declarative configuration model for networks, servers, services, security, requirements, etc. For example, the ACI framework implements EPGs, which can include a collection of endpoints or applications that share common configuration requirements, such as security, QoS, services, etc. Endpoints can be virtual/logical or physical devices, such as VMs, containers, hosts, or physical servers that are connected to Network Environment 200. Endpoints can have one or more attributes such as a VM name, guest OS name, a security tag, application profile, etc. Application configurations can be applied between EPGs, instead of endpoints directly, in the form of contracts. Leafs 204 can classify incoming traffic into different EPGs. The classification can be based on, for example, a network segment identifier such as a VLAN ID, VXLAN Network Identifier (VNID), NVGRE Virtual Subnet Identifier (VSID), MAC address, IP address, etc.

In some cases, classification in the ACI infrastructure can be implemented by Application Virtual Switches (AVS), which can run on a host, such as a server or switch. For example, an AVS can classify traffic based on specified attributes, and tag packets of different attribute EPGs with different identifiers, such as network segment identifiers (e.g., VLAN ID). Finally, Leafs 204 can tie packets with their attribute EPGs based on their identifiers and enforce policies, which can be implemented and/or managed by one or more Controllers 216. Leaf 204 can classify to which EPG the traffic from a host belongs and enforce policies accordingly.

Another example SDN solution is based on VMWARE NSX. With VMWARE NSX, hosts can run a distributed firewall (DFW) which can classify and process traffic. Consider a case where three types of VMs, namely, application, database and web VMs, are put into a single layer-2 network segment. Traffic protection can be provided within the network segment based on the VM type. For example, HTTP traffic can be allowed among web VMs, and disallowed between a web VM and an application or database VM. To classify traffic and implement policies, VMWARE NSX can implement security groups, which can be used to group the specific VMs (e.g., web VMs, application VMs, database VMs). DFW rules can be configured to implement policies for the specific security groups. To illustrate, in the context of the previous example, DFW rules can be configured to block HTTP traffic between web, application, and database security groups.

Returning now to FIG. 2A, Network Environment 200 can deploy different hosts via Leafs 204, Servers 206, Hypervisors 208, VMs 210, Applications 212, and Controllers 216, such as VMWARE ESXi hosts, WINDOWS HYPER-V hosts, bare metal physical hosts, etc. Network Environment 200 may interoperate with a variety of Hypervisors 208, Servers 206 (e.g., physical and/or virtual servers), SDN orchestration platforms, etc. Network Environment 200 may implement a declarative model to allow its integration with application design and holistic network policy.

Controllers 216 can provide centralized access to fabric information, application configuration, resource configuration, application-level configuration modeling for a software-defined network (SDN) infrastructure, integration with management systems or servers, etc. Controllers 216 can form a control plane that interfaces with an application plane via northbound APIs and a data plane via southbound APIs.

As previously noted, Controllers 216 can define and manage application-level model(s) for configurations in Network Environment 200. In some cases, application or device configurations can also be managed and/or defined by other components in the network. For example, a hypervisor or virtual appliance, such as a VM or container, can run a server or management tool to manage software and services in Network Environment 200, including configurations and settings for virtual appliances.

As illustrated above, Network Environment 200 can include one or more different types of SDN solutions, hosts, etc. For the sake of clarity and explanation purposes, various examples in the disclosure will be described with reference to an ACI framework, and Controllers 216 may be interchangeably referenced as controllers, APICs, or APIC controllers. However, it should be noted that the technologies and concepts herein are not limited to ACI solutions and may be implemented in other architectures and scenarios, including other SDN solutions as well as other types of networks which may not deploy an SDN solution.

Further, as referenced herein, the term “hosts” can refer to Servers 206 (e.g., physical or logical), Hypervisors 208, VMs 210, containers (e.g., Applications 212), etc., and can run or include any type of server or application solution. Non-limiting examples of “hosts” can include virtual switches or routers, such as distributed virtual switches (DVS), application virtual switches (AVS), vector packet processing (VPP) switches; VCENTER and NSX MANAGERS; bare metal physical hosts; HYPER-V hosts; VMs; DOCKER Containers; etc.

FIG. 2B illustrates another example of Network Environment 200. In this example, Network Environment 200 includes Endpoints 222 connected to Leafs 204 in Fabric 220. Endpoints 222 can be physical and/or logical or virtual entities, such as servers, clients, VMs, hypervisors, software containers, applications, resources, network devices, workloads, etc. For example, an Endpoint 222 can be an object that represents a physical device (e.g., server, client, switch, etc.), an application (e.g., web application, database application, etc.), a logical or virtual resource (e.g., a virtual switch, a virtual service appliance, a virtualized network function (VNF), a VM, a service chain, etc.), a container running a software resource (e.g., an application, an appliance, a VNF, a service chain, etc.), storage, a workload or workload engine, etc. Endpoints 122 can have an address (e.g., an identity), a location (e.g., host, network segment, virtual routing and forwarding (VRF) instance, domain, etc.), one or more attributes (e.g., name, type, version, patch level, OS name, OS type, etc.), a tag (e.g., security tag), a profile, etc.

Endpoints 222 can be associated with respective Logical Groups 218. Logical Groups 218 can be logical entities containing endpoints (physical and/or logical or virtual) grouped together according to one or more attributes, such as endpoint type (e.g., VM type, workload type, application type, etc.), one or more requirements (e.g., policy requirements, security requirements, QoS requirements, customer requirements, resource requirements, etc.), a resource name (e.g., VM name, application name, etc.), a profile, platform or operating system (OS) characteristics (e.g., OS type or name including guest and/or host OS, etc.), an associated network or tenant, one or more policies, a tag, etc. For example, a logical group can be an object representing a collection of endpoints grouped together. To illustrate, Logical Group 1 can contain client endpoints, Logical Group 2 can contain web server endpoints, Logical Group 3 can contain application server endpoints, Logical Group N can contain database server endpoints, etc. In some examples, Logical Groups 218 are EPGs in an ACI environment and/or other logical groups (e.g., SGs) in another SDN environment.

Traffic to and/or from Endpoints 222 can be classified, processed, managed, etc., based Logical Groups 218. For example, Logical Groups 218 can be used to classify traffic to or from Endpoints 222, apply policies to traffic to or from Endpoints 222, define relationships between Endpoints 222, define roles of Endpoints 222 (e.g., whether an endpoint consumes or provides a service, etc.), apply rules to traffic to or from Endpoints 222, apply filters or access control lists (ACLs) to traffic to or from Endpoints 222, define communication paths for traffic to or from Endpoints 222, enforce requirements associated with Endpoints 222, implement security and other configurations associated with Endpoints 222, etc.

In an ACI environment, Logical Groups 218 can be EPGs used to define contracts in the ACI. Contracts can include rules specifying what and how communications between EPGs take place. For example, a contract can define what provides a service, what consumes a service, and what policy objects are related to that consumption relationship. A contract can include a policy that defines the communication path and all related elements of a communication or relationship between endpoints or EPGs. For example, a Web EPG can provide a service that a Client EPG consumes, and that consumption can be subject to a filter (ACL) and a service graph that includes one or more services, such as firewall inspection services and server load balancing.

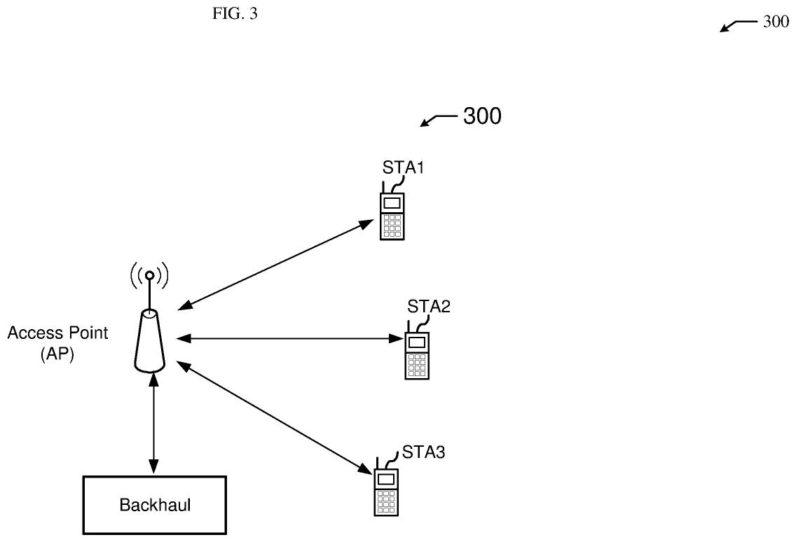

FIG. 3 illustrates an example wireless communication network 300 in which some aspects of the technology can be implemented. Specifically, the wireless communication network 300 can form, at least in part, an overall network/wireless network that is used to provide network service access.

FIG. 3 illustrates an Access Point (AP), configured for wireless communication with multiple receivers or client devices/stations (e.g., STA1, STA2, and STA3). It is understood that additional (or fewer) STAs and/or APs could be implemented in network 300, without departing from the scope of the technology. The AP is coupled to a backhaul that is used to transmit data to and from the AP.

The AP may have access or interface to a Distribution System (DS) or another type of wired/wireless network that may carry traffic in and out of a basic service set (herein referred to as “BSS”), e.g. one or more STAs and one or more APs, of the wireless network 300. Thus traffic to STAs can originate from outside the BSS, and arrive through the AP for delivery to the STAs. Conversely, traffic originating from STAs to destinations outside the BSS can be sent to the AP to be delivered to the respective destinations. Traffic between STAs within the BSS can be sent through the AP where the source STA may send traffic to the AP and the AP may deliver the traffic to the destination STA. The traffic between STAs within a BSS may be peer-to-peer traffic. The AP and the STAs can exchange data using an applicable wireless protocol. Specifically, the AP and the STAs can be IEEE 802.11ax compliant and communicate according to the IEEE 802.11ax standard.

Using the IEEE 802.11 infrastructure mode of operation, the AP can transmit on a fixed channel, for example that is 20 MHz wide, and designated as the operating channel of the BSS. This channel may also be used by the STAs to establish a connection with the AP. The channel access in an IEEE 802.11 system may be Carrier Sense Multiple Access with Collision Avoidance (CSMA/CA). In this mode of operation, the STAs, including the AP, can sense the primary channel. If the channel is detected to be busy, the STA may back off. If the channel is detected to be free, the STA may acquire the channel and transmit data.

It is understood that network 300 can implement various wireless standards using different channel sizes (bandwidths), without departing from the technology. By way of example, IEEE 802.11n, High Throughput (HT) STAs may be used, e.g., implementing a 40 MHz communication channel. This can be achieved, for example, by combining a primary 20 MHz channel, with an adjacent 20 MHz channel to form a 40 MHz wide contiguous channel. In IEEE 802.11a/c, very high throughput (VHT) STAs can also be supported, e.g., 20 MHz, 40 MHz, 80 MHz, and/or 160 MHz wide channels. The 40 MHz, and 80 MHz, channels can be formed, e.g., by combining contiguous 20 MHz channels. A 160 MHz channel may be formed, for example, by combining eight contiguous 20 MHz channels, or by combining two non-contiguous 80 MHz channels (e.g., referred to as an 80+80 configuration).

Uplink latency in a network including a wireless network and a backhaul can be hindered by latency in the backhaul. Uplink latency, as used herein, refers to latency in transmitting uplink data through the wireless network and the backhaul towards a core of the network. Specifically, a wireless networking device, e.g. access point, can receive data over a wireless connection of the wireless network. However, due to latency in the backhaul of the wireless network, transmission of the data, e.g. as uplink data, through the backhaul can ultimately be delayed. In turn, this can increase overall latency in the network. There therefore exist needs for systems and methods for reducing uplink latency in a wireless network and a corresponding backhaul. Specifically, there exist needs for coordinating a scheduler of the wireless network with a scheduler of the backhaul to reduce uplink latency in the network.

Mobile-aware scheduling for backhauls, e.g. backhauls with high latency, has already been proposed to improve the uplink user equipment-to-mobile core latency by coordinating the Long-Term Evolution (herein referred to as “LTE”) and Data Over Cable Service Interface Specifications (herein referred to as “DOCSIS”) scheduling operations. DOCSIS is a commonly used scheduling mechanism for Wi-Fi backhauls, especially for residential and small or medium-sized business cases. From a Wi-Fi wireless network perspective, scheduled transmission is first introduced in IEEE 802.11ax. However, mechanisms have not been developed for coordinating DOCSIS schedulers with 802.11ax schedulers. In particular, 802.11ax based wireless networks can still experience overall latency issues due to latency in network backhauls of the Wi-Fi networks. Specifically, the timing and operations of 802.11ax schedulers is different from the timing and operations of both LTE and DOCSIS schedulers. There therefore exist needs for systems and methods for coordinating the 802.11ax and DOCSIS schedulers to reduce the overall uplink system latency.

In order to address these challenges wireless schedulers and backhaul schedulers are coordinated to control transmission of data over wireless connections of a wireless network and a backhaul of a wireless network. In particular, the present can include system, methods, and computer-readable mediums for coordinating an 802.11ax scheduler for an 802.11ax compliant wireless network and a DOCSIS scheduler of a backhaul of the wireless network. A wireless scheduler of a wireless network can identify an uplink data prediction for uplink data to transmit over a wireless connection of the wireless network. The uplink data prediction can be provided to a backhaul scheduler of a backhaul of the wireless network. The backhaul scheduler and the wireless scheduler can be coordinated by configuring the backhaul scheduler to coordinate transmission of the uplink data through the backhaul based on the uplink data prediction. Coordinating the backhaul scheduler and the wireless scheduler using the uplink data prediction can reduce an amount of time between when the uplink data is received at the backhaul and when the uplink data is actually transmitted through the backhaul. For example, the backhaul scheduler can prepare to generate an uplink transmission grant for the uplink data ahead of time, and at the time the uplink data is actually received at the backhaul, the grant in the backhaul network is already available to use. In turn, this can decrease latency across the wireless network.

FIG. 4 is a wireless network environment 400 and a corresponding communication timing diagram for coordinating schedulers between a wireless network and a backhaul network. The wireless network environment 400 functions to provide network service access to stations. Specifically, the wireless network environment 400 functions to provide network service access to stations through both wireless connections of a wireless network and a backhaul of the wireless network. The wireless network environment 400 can provide network service access through an applicable network environment, such as the network environments 200 shown in FIGS. 2A and 2B. Further, the wireless network environment 400 can provide network service access through either or both an applicable cloud computing architecture or a fog computing architecture, such as the example cloud computing architecture 100 and the example fog computing architecture 150 shown in FIGS. 1A and 1B.

The wireless network environment 400 shown in FIG. 4 includes a station 402 and an access point 404. The station 402 and the access point 404 can be connected as part of an applicable wireless network, such as the wireless communication network 300 shown in FIG. 3. Specifically, the station 402 and the access point 404 can be connected as part of a WiFi network, such as the example wireless communication network 300 shown in FIG. 3. More specifically, the station 402 and the access point 404 can be IEEE 802.11ax protocol and be configured to communicate wirelessly according to the IEEE 802.11ax protocol. While the station 402 and the access point 404 are described herein with respect to a WiFi network and the IEEE 802.11ax protocol, in various embodiments, the station 402 and the access point 404 can be configured to communicate using an applicable wireless protocol to form, at least in part, a wireless network. Specifically, the station 402 and the access point 404 can form part of an applicable wireless network that utilizes wireless scheduling to coordinate data transmission between the station 402 and the access point 404.

The wireless network environment 400 shown in FIG. 4 includes a backhaul coupled to the access point 404. The backhaul functions to transmit data received from the station 402 at the access point 404 to an endpoint, e.g. as uplink data, for providing the station 402 network service access. For example, the backhaul can transmit uplink data of the station 402 to a cloud environment for providing the station 402 access to network services over a wireless network through the access point 404. Conversely, the backhaul can transmit data from an endpoint to the access point 404. The access point 404 can then transmit this data to the station 402 as part of providing the station 402 access to network services over a wireless network. All or portions of the backhaul can either be wired or wireless. For example, the backhaul can include one or a plurality of devices configured to receive data from the access point 404 over a wireless connection and to subsequently forward the data to an endpoint in a network environment through wired connections.

Additionally, the wireless network environment 400 shown in FIG. 4 includes a wireless scheduler 408 and a backhaul scheduler 410 implemented in the backhaul. The wireless scheduler 408 functions to schedule transmission of data between the station 402 and the access point 404. In particular, the wireless scheduler 408 functions to schedule transmission of uplink data sent from the station 402 to the access point 404. The wireless scheduler 408 can schedule a time when the station 402 can provide data to the access point 404. For example, the wireless scheduler 408 can send a trigger from the access point 404 to the station 402 to cause the station 402 to transmit uplink data to the access point 404, effectively scheduling the transmission the transmission of the uplink data. The wireless scheduler 408 can be implemented according to an applicable wireless protocol that provides for scheduled transmission of data over a wireless link, such as IEEE 802.11ax.

The backhaul scheduler 410 functions to schedule transmission of data sent through the backhaul. Specifically, the backhaul scheduler 410 can schedule transmission of uplink data received at the access point 404 through the backhaul to an endpoint. For example, the backhaul scheduler 410 can provide an upstream grant to a slave node 406 in the backhaul as part of scheduling transmission of uplink data received at the access point 404 through the backhaul. The backhaul scheduler 410 can be implemented according to an applicable standard for scheduling transmission over a backhaul in a wireless network. For example, the backhaul scheduler 410 can be a DOCSIS scheduler for coordinating scheduled transmission of data through the backhaul.

The wireless network environment 400 also includes a wireless scheduler and backhaul scheduler coordinating system 412. The wireless scheduler and backhaul scheduler coordinating system 412 functions to coordinate the wireless scheduler 408 and the backhaul scheduler 410. Specifically, the wireless scheduler and backhaul scheduler coordinating system 412 can coordinate the wireless scheduler 408 and the backhaul scheduler 410 for purposes of controlling transmission of data over either or both the wireless network formed between the station 402 and the access point 404 and the backhaul network formed at least in part between the slave node 406 and the backhaul scheduler 410. In coordinating the wireless scheduler 408 and the backhaul scheduler 410, the wireless scheduler and backhaul scheduler coordinating system 412 can be implemented at either or both the wireless scheduler 408 and the backhaul scheduler 410. For example, the wireless scheduler and backhaul scheduler coordinating system 412, when implemented at the wireless scheduler 408, can send uplink data prediction to the backhaul scheduler 410 ahead of time for coordinating the wireless scheduler 408 and the backhaul scheduler 410 to transmit data, e.g. uplink data.

In current wireless networks that include both a wireless scheduler and a backhaul scheduler, latency in the backhaul can increase overall uplink latency in the network. This can be due to the fact that the wireless scheduler and the backhaul scheduler are not coordinated for transmission of data, e.g. uplink data, in current wireless networks. For example, in current wireless networks, DOCSIS schedulers are not coordinated with 802.11ax schedulers, which can lead to uplink latency in the networks.

In order to transmit data through a backhaul, a backhaul scheduler provides a grant, e.g. a grant of upstream bandwidth, to allow the data traverse backhaul. The slave node (e.g., cable modem in the case of DOCSIS as backhaul network) can then transmit uplink data received at an access point from the station using the grant. However, as the wireless scheduler and the backhaul scheduler are uncoordinated in current wireless networks, uplink data arrives at the backhaul before a grant for transmitting the uplink data through the backhaul is issued by the backhaul scheduler. For example, a wireless scheduler can schedule transmission of uplink data that is subsequently received at the access point. The access point can then provide the uplink data to the backhaul. As the wireless scheduler and the backhaul scheduler are uncoordinated , a slave node (e.g., cable modem in the case of DOCSIS network as backhaul network) has to request for a grant from the backhaul scheduler once the uplink data is received at the slave node. The backhaul scheduler can then provide the grant which can be used to transmit the uplink data through the backhaul. The time between when the uplink data is received at the backhaul and when the backhaul scheduler provides the grant can unnecessarily increase the total amount of time it takes to transmit the uplink data through the backhaul. In turn, this can increase overall uplink latency in the wireless network.

In coordinating the wireless scheduler 408 and the backhaul scheduler 410, the wireless scheduler and backhaul scheduler coordination system 412 can provide an uplink data prediction to the backhaul scheduler 410. Specifically, the wireless scheduler and backhaul scheduler coordination system 412, implemented at the wireless scheduler 408, can formulate an uplink data prediction and provide the uplink data prediction to the backhaul scheduler 410. The wireless scheduler and backhaul scheduler coordination system 412 can formulate the uplink data prediction, as will be discussed in greater detail later, before specific uplink data is received at the access point 404, e.g. through scheduled transmission by the wireless scheduler 408. Subsequently, the backhaul scheduler 410 can use the uplink data prediction to generate a grant for uplink data before the uplink data is received at the access point 404 and/or before the uplink data is received at the slave node 406. The uplink data can then be transmitted through the backhaul, using the grant, once the uplink data is received at the slave node 406. This can reduce an amount of time between when the uplink data is received at the backhaul, e.g. at the slave node 406, and when the uplink data is transmitted through the backhaul, e.g. because the grant is given to the backhaul before the uplink data arrives at the backhaul. In turn, this can reduce uplink latency through the wireless network.

An uplink data prediction generated by the wireless scheduler and backhaul scheduler coordination system 412 can include applicable prediction characteristics of uplink data that will be received at the access point 404 from the station 402. Specifically, an uplink data prediction generated by the wireless scheduler and backhaul scheduler coordination system 412 can include a prediction of at least one of an arrival time of the uplink data, an amount of traffic in the uplink data, and quality of service (herein referred to as “QoS”) requirement for the uplink data, a user associated with the uplink data, a traffic arrival rate of the uplink data, and a data type of the uplink data. For example, an uplink data prediction can include whether predicted uplink data will be a burst of data or a persistent stream of data, e.g. as indicated by predicted arrival rates of uplink data.

The wireless scheduler and backhaul scheduler coordination system 412 can identify an uplink data prediction based on downlink traffic. Downlink traffic, as used herein, includes data that is transmitted back towards the station 402 from a core of a network through the backhaul and the access point 404. Downlink traffic can be associated with or otherwise correspond to uplink traffic transmitted from the station 402 through the wireless network environment. For example, if downlink TCP traffic is sent to the station, then TCP acknowledgment can be sent as uplink traffic corresponding to the downlink TCP traffic.

In using downlink traffic to identify an uplink data prediction, the wireless scheduler and backhaul scheduler coordination system 412 can inspect the downlink traffic as it is received at the access point 404 from the slave node 406 to identify an uplink data prediction. Specifically, the wireless scheduler and backhaul scheduler coordination system 412 can perform deep packet inspection to data packets in downlink traffic at the access point 404 to identify an uplink data prediction. For example, the wireless scheduler and backhaul scheduler coordination system 412 can perform deep packet inspection on downlink traffic to predict a size of uplink responses to the downlink traffic and expected arrival times of the uplink responses to the downlink traffic at the access point 404.

Further, in using downlink traffic to identify an uplink data prediction, the wireless scheduler and backhaul scheduler coordination system 412 can correlate downlink traffic and identify an uplink data prediction from the correlated downlink traffic. Specifically, the wireless scheduler and backhaul scheduler coordination system 412 can group together data packets in downlink traffic and streams of data in downlink traffic, e.g. transmission control protocol acknowledgments, quick UDP internet connection acknowledgments, and application layer responses, as part of correlating the downlink traffic to create correlated downlink traffic. The wireless scheduler and backhaul scheduler coordination system 412 can correlate downlink traffic based on characteristics of the downlink traffic such as one or a combination of a user/station associated with the downlink traffic, a data type of data in downlink traffic, and traffic arrival rates of downlink traffic. Subsequently, the wireless scheduler and backhaul scheduler coordination system 412 can inspect the correlated downlink traffic to identify an uplink data prediction. For example, the wireless scheduler and backhaul scheduler coordination system 412 can inspect a data size of correlated downlink traffic for a specific station to predict a data size for predicted uplink data for the specific station.

The wireless scheduler and backhaul scheduler coordination system 412 can identify an uplink data prediction based on uplink data transmitted through the wireless network environment 400. In particular, the wireless scheduler and backhaul scheduler coordination system 412 can use buffer status reports to identify uplink data predictions. Specifically, the wireless scheduler and backhaul scheduler coordination system 412 can use a buffer status report received by the wireless scheduler 408 to identify uplink data predictions. For example, a buffer status report indicating an amount of uplink data that will be transmitted from the station 402 and a time at which the uplink data will be transmitted from the station 402 can be maintained by the wireless scheduler 408 of the access point 404, e.g. using trigger frames. The wireless scheduler and backhaul scheduler coordination system 412 can then make an uplink data prediction for the uplink data based on the buffer status report, e.g. based on an indication of the amount of data in the uplink data in the buffer status report.

Alternatively, the wireless scheduler and backhaul scheduler coordination system 412 can identify an uplink data prediction based on traffic patterns of uplink data transmitted through the network environment 400. For example, if uplink data patterns of a specific station indicate that the station typically sends 100 bytes of uplink data, then the wireless scheduler and backhaul scheduler coordination system 412 can generate an uplink data prediction including an estimation of 100 bytes of uplink data size for the specific station. In another example, if traffic patterns of a specific station indicate that the station typically sends uplink data every 1 ms, then the wireless scheduler and backhaul scheduler coordination system 412 can generate an uplink data prediction including an estimation that uplink data will be received from the specific station at the access point 404 every 1 ms. The wireless scheduler and backhaul scheduler coordination system 412 can use traffic patterns of uplink data transmitted through the wireless network environment 400 if buffer status reports are unavailable or otherwise not maintained for the uplink data transmitted through the wireless network environment 400.

The wireless scheduler and backhaul scheduler coordination system 412 can analyze traffic over a specific data window to identify patterns of uplink data transmission in the network environment 400. Subsequently, the wireless scheduler and backhaul scheduler coordination system 412 can use the patterns of uplink data transmission in the specific data window, e.g. sliding time window, to formulate uplink data predictions. Further, the wireless scheduler and backhaul scheduler coordination system 412 can use machine learning/deep learning to identify patterns of uplink data transmission in the network environment 400. Subsequently, the wireless scheduler and backhaul scheduler coordination system 412 can use the patterns of uplink data transmission identified through machine learning to formulate uplink data predictions.

The wireless scheduler and backhaul scheduler coordination system 412 can provide an uplink data prediction, e.g. through the wireless scheduler 408, to the backhaul scheduler 410. The backhaul scheduler 410 can then use the uplink data prediction to provide upstream grants for transmitting uplink data through the backhaul, e.g. as part of coordinating the backhaul scheduler 410 and the wireless scheduler 408. Specifically, the backhaul scheduler 410 can provide upstream grants for transmitting uplink data to the backhaul before the uplink data is received at the access point 404 and/or before the uplink data is received at the backhaul 406 through the access point 404. Further, the backhaul scheduler 410 can provide upstream grants based on a configuration of the backhaul network, e.g. configurations of cable modems and cable modem termination systems and distances between the cable modems and cable modem termination systems in the backhaul. Additionally, the backhaul scheduler 410 can provide upstream grants based on a type of service flow used to transmit a request for an uplink grant through the backhaul.

In providing an upstream grant based on the uplink data prediction, the backhaul scheduler 410 can allocate a grant size of transmittable data for the grant based on the uplink data prediction. For example, if an uplink data prediction indicates predicted uplink data will be a burst of data, then the backhaul scheduler 410 can provide a grant with a large grant size of transmittable data. Alternatively, if an uplink data prediction indicates predicted uplink data will be a persistent flow of data, then the backhaul scheduler 410 can provide a grant with a small grant size of transmittable data.

The wireless scheduler and backhaul scheduler coordination system 412 can also generate an estimate of accuracy of an uplink data prediction it makes. An estimation of accuracy of an uplink data prediction can include a numerical indication of how uncertain an uplink data prediction accurately characterizes uplink data for transmission through the backhaul. For example, an estimation of accuracy can indicate an uplink data prediction is 80% likely to accurately characterize uplink data for transmission through the backhaul. Further, the wireless scheduler and backhaul scheduler coordination system 412 can estimate an accuracy of an uplink data prediction based on one or a combination of uncertainty of channel access, a possibility of a re-transmission, traffic patterns and traffic priorities of other clients, and user behaviors. For example, if a large number of clients have higher priority traffic than current uplink data, then the wireless scheduler and backhaul scheduler coordination system 412 can decreases its estimate of accuracy of an uplink data prediction for the current uplink data.

Further, the wireless scheduler and backhaul scheduler coordination system 412 can maintain prediction statistics of uplink data. The wireless scheduler and backhaul scheduler coordination system 412 can maintain the prediction statistics as the wireless scheduler and backhaul scheduler coordination system 412 coordinates the wireless scheduler 408 and the backhaul scheduler 410, e.g. using uplink data predictions. Prediction statics include applicable information regarding either or both current and past uplink data, as well as corresponding uplink data predictions for either or both current and past uplink data. For example, prediction statistics can include a time when a prediction was made, a time when corresponding uplink data to an uplink data prediction is received, e.g. at the access point 404 and/or the backhaul, an accuracy of an uplink data prediction, and a QoS requirement of the uplink data, e.g. through a QoS class identifier (herein referred to as “QCI”). More specifically, prediction statistics can include a predicted arrival times of past uplink data at the backhaul and actual arrival times of the uplink data at the backhaul.

The wireless scheduler and backhaul scheduler coordination system 412 can estimate an accuracy of an uplink data prediction based on maintained prediction statistics of uplink data predictions. Further, the wireless scheduler and backhaul scheduler coordination system 412 can estimate an accuracy of an uplink data prediction based on one or a combination of a user/station originating the uplink data, a device/station generating the uplink data, and a data type of the uplink data. Specifically, the wireless scheduler and backhaul scheduler coordination system 412 can estimate accuracy of an uplink data prediction using prediction statistics analyzed based on one or a combination of a user originating the uplink data, a device generating the uplink data, and a data type of the uplink data. For example, if uplink data for a specific station always arrives late at the access point 404, as indicated by prediction statistics, then the wireless scheduler and backhaul scheduler coordination system 412 can reduce its accuracy estimation for uplink data predictions of uplink data sent from the station.

The wireless scheduler and backhaul scheduler coordination system 412 can provide prediction statistics including an estimate of accuracy of an uplink data prediction to the backhaul scheduler 410. Subsequently, the backhaul scheduler 410 can provide grants according to the provided prediction statistics and/or the accuracy estimate of an uplink data prediction. For example, the backhaul scheduler 410 can provide a grant based on a QoS requirement for uplink data included as part of the prediction statistics for the uplink data. In another example, the backhaul scheduler 410 can first issue grants to uplink data with uplink data predictions having higher accuracy estimations before issuing grants to uplink data uplink data prediction having lower accuracy estimations.

FIG. 4 includes a corresponding example timing diagram of data sent through the wireless network environment 400 as part of coordinating the wireless scheduler 408 and the backhaul scheduler 410. First, at 414, an uplink data prediction is sent from the access point 404 to the slave node 406. Subsequently, at 416, the uplink data prediction is sent from the slave node 406 to the backhaul scheduler 410. Specifically, the wireless scheduler and backhaul scheduler coordination system 412, e.g. implemented as part of the wireless scheduler 408, can send the uplink data prediction to the backhaul scheduler 410, at 414 and 416.

At 420, the access point 404 can send a trigger for uplink data to the station 402. Specifically, the wireless scheduler 408 can cause the access point 404 to send a trigger as part of scheduling transmission of uplink data over the wireless network to the access point 404. Subsequently the station 402 can send uplink data back to the access point 404, at 422. The uplink data can then be transmitted, at 424, from the access point 404 to the slave node 406.

Further, at 418, the backhaul scheduler 410 can provide an upstream grant to the slave node 406 before the uplink data is received by the backhaul, at 424. While the upstream grant in the example timing diagram shows that the upstream grant, at 418, is given after the trigger is sent from the access point 404 to the station 402, in various embodiments, the upstream grant can be given before the trigger is sent from the access point to the station 402, at 420. The upstream grant can be generated by the backhaul scheduler 410 according to the techniques described herein, e.g. using the uplink data prediction received by the backhaul scheduler 410, at 416. Subsequently, the uplink data can be transmitted through the slave node 406, at 426, using the upstream grant given at 418. Specifically, the uplink data can be transmitted through the backhaul without having to wait for the upstream grant to be given after the uplink data arrives at the slave node 406. In turn, this can decrease uplink latency through the entire wireless network environment 400.

FIG. 5 illustrates a flowchart for an example method of coordinating a wireless scheduler and a backhaul scheduler in a wireless network to decrease uplink latency. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated.

Each module shown in FIG. 5 represents one or more steps, processes, methods or routines in the method. For the sake of clarity and explanation purposes, the modules in FIG. 5 are described with reference to the wireless network environment 400 shown in FIG. 4.

At step 500, the wireless scheduler and backhaul scheduler coordination system 412 implemented at the wireless scheduler 408 of a wireless network, identifies an uplink data prediction for uplink data to transmit over a wireless connection of the wireless network. The wireless scheduler and backhaul scheduler coordination system 412 can identify the uplink data prediction based on downlink traffic transmitted through the wireless network. Alternatively, the wireless scheduler and backhaul scheduler coordination system 412 can identify the uplink data prediction based on uplink traffic transmitted through the wireless network. The wireless scheduler and backhaul scheduler coordination system 412 can identify the uplink data prediction before the access point 404 sends a trigger for the uplink data.

At step 502, the wireless scheduler and backhaul scheduler coordination system 412 provides the uplink data prediction to the backhaul scheduler 410. The wireless scheduler and backhaul scheduler coordination system 412 can provide the uplink data prediction to the backhaul scheduler 410 through the access point 404. Further, the wireless scheduler and backhaul scheduler coordination system 412 can provide the uplink data prediction to the backhaul scheduler 410 through the backhaul, e.g. slave node 406.

At step 504, the wireless scheduler 408 is coordinated with the backhaul scheduler 410 to transmit uplink data through the wireless network. Specifically, the backhaul scheduler 410 can be configured to coordinate transmission of the uplink data through the backhaul based on the uplink data prediction. More specifically, the backhaul scheduler 410 can generate an uplink grant based on the uplink data prediction that can subsequently be used to transmit the uplink data through the backhaul. The uplink grant can be issued by the backhaul scheduler 410 before the uplink data actually arrives at the slave node 406. In turn, the uplink data can be transmitted through the backhaul as it arrives at the slave node 406 using the upstream grant, thereby reducing uplink network latency.

At step 506, the uplink data is received at the backhaul, e.g. slave node 406, for transmission through the backhaul based on the uplink data prediction. Specifically, the uplink data can be received at the slave node 406 after an uplink grant is issued for transmitting the uplink data through the backhaul. The uplink data can be received at the slave node 406 from the access point 404. Further, the uplink data can be received at the access point 404 through a scheduled transmission from the station 402 that is coordinated by the wireless scheduler 408.

The disclosure now turns to FIGS. 6 and 7, which illustrate example network devices and computing devices, such as switches, routers, load balancers, client devices, and so forth.

FIG. 6 illustrates a computing system architecture 600 wherein the components of the system are in electrical communication with each other using a connection 605, such as a bus. Exemplary system 600 includes a processing unit (CPU or processor) 610 and a system connection 605 that couples various system components including the system memory 615, such as read only memory (ROM) 720 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware or software service, such as service 1 632, service 2 634, and service 3 636 stored in storage device 630, configured to control the processor 610 as well as a special-purpose processor where software instructions are incorporated into the actual processor design. The processor 610 may be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include services 632, 634, 636 for controlling the processor 610. Other hardware or software modules are contemplated. The storage device 630 can be connected to the system connection 605. In one aspect, a hardware module that performs a particular function can include the software component stored in a computer-readable medium in connection with the necessary hardware components, such as the processor 610, connection 605, output device 635, and so forth, to carry out the function.

FIG. 7 illustrates an example network device 700 suitable for performing switching, routing, load balancing, and other networking operations. Network device 700 includes a central processing unit (CPU) 704, interfaces 702, and a bus 710 (e.g., a PCI bus). When acting under the control of appropriate software or firmware, the CPU 704 is responsible for executing packet management, error detection, and/or routing functions. The CPU 704 preferably accomplishes all these functions under the control of software including an operating system and any appropriate applications software. CPU 704 may include one or more processors 708, such as a processor from the INTEL X86 family of microprocessors. In some cases, processor 708 can be specially designed hardware for controlling the operations of network device 700. In some cases, a memory 706 (e.g., non-volatile RAM, ROM, etc.) also forms part of CPU 704. However, there are many different ways in which memory could be coupled to the system.

The interfaces 702 are typically provided as modular interface cards (sometimes referred to as “line cards”). Generally, they control the sending and receiving of data packets over the network and sometimes support other peripherals used with the network device 700. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master CPU 704 to efficiently perform routing computations, network diagnostics, security functions, etc.

Although the system shown in FIG. 7 is one specific network device of the present technology, it is by no means the only network device architecture on which the present technology can be implemented. For example, an architecture having a single processor that handles communications as well as routing computations, etc., is often used. Further, other types of interfaces and media could also be used with the network device 700.

Regardless of the network device's configuration, it may employ one or more memories or memory modules (including memory 706) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 706 could also hold various software containers and virtualized execution environments and data.

The network device 700 can also include an application-specific integrated circuit (ASIC), which can be configured to perform routing and/or switching operations. The ASIC can communicate with other components in the network device 700 via the bus 710, to exchange data and signals and coordinate various types of operations by the network device 700, such as routing, switching, and/or data storage operations, for example.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

1. A method comprising:
identifying, by a wireless scheduler of a wireless network, an uplink data prediction for uplink data to transmit over a wireless connection of the wireless network, wherein the uplink data prediction is made before the uplink data is received at the backhaul and the uplink data prediction includes a prediction of at least one of an arrival time of the uplink data, an amount of traffic in the uplink data, quality of service requirements for the uplink data, a user associated with the uplink data, a traffic arrival rate of the uplink data, and a data type of the uplink data;
providing the uplink data prediction to a backhaul scheduler of a backhaul of the wireless network;
coordinating the wireless scheduler with the backhaul scheduler by configuring the backhaul scheduler to coordinate transmission of the uplink data through the backhaul based on the uplink data prediction; and
receiving the uplink data at the backhaul for transmission through the backhaul based on the uplink data prediction.

2. The method of claim 1, wherein the uplink data prediction is generated before the uplink data is generated and transmitted over the wireless connection of the wireless network.

3. The method of claim 1, wherein the wireless network is an IEEE 802.11ax compliant wireless network.

4. (canceled)

5. The method of claim 1, further comprising identifying the uplink data prediction from downlink traffic transmitted through the wireless network over the wireless connection and the backhaul of the wireless network.

6. The method of claim 5, further comprising:
correlating the downlink traffic to create correlated downlink traffic; and
identifying the uplink data prediction based on the correlated downlink traffic.

7. The method of claim 1, further comprising identifying the uplink data prediction from traffic patterns of uplink data transmitted through the wireless network over the wireless connection and the backhaul of the wireless network.

8. The method of claim 7, further comprising using one or more buffer status reports for the uplink data transmitted through the wireless network over the wireless connection and the backhaul of the wireless network to identify the uplink data prediction.

9. The method of claim 7, wherein the traffic patterns of the uplink data transmitted through the wireless network are identified using machine learning.

10. The method of claim 1, further comprising:
identifying an estimate of an accuracy of the uplink data prediction; and
providing the estimate of the accuracy of the uplink data prediction with the uplink data prediction to the backhaul scheduler to coordinate transmission of the uplink data through the backhaul based on the uplink data prediction and the accuracy of the uplink data prediction.

11. The method of claim 10, wherein the estimate of the accuracy of the uplink data prediction is identified based on maintained prediction statistics of either or both past uplink traffic and current uplink traffic.

12. The method of claim 11, wherein the prediction statistics include predicted arrival times of the past uplink traffic at the backhaul of the wireless network and actual arrival times of the past uplink traffic at the backhaul of the wireless network.

13. The method of claim 10, wherein the estimate of the accuracy of the uplink data prediction is identified based on one or a combination of a user originating the uplink data, a device generating the uplink data, and a data type of the uplink data.

14. The method of claim 1, further comprising generating, by the backhaul scheduler based on the uplink data prediction and before the uplink data is received at the backhaul, an uplink grant for transmitting the uplink data through the backhaul.

15. A system comprising:
one or more processors; and
at least one computer-readable storage medium having stored therein instructions which, when executed by the one or more processors, cause the one or more processors to perform operations comprising:
identifying, by a wireless scheduler of a wireless network, an uplink data prediction for uplink data to transmit over a wireless connection of the wireless network, wherein the uplink data prediction is made before the uplink data is received at the backhaul and the uplink data prediction includes a prediction of at least one of an arrival time of the uplink data, an amount of traffic in the uplink data, quality of service requirements for the uplink data, a user associated with the uplink data, a traffic arrival rate of the uplink data, and a data type of the uplink data;
providing the uplink data prediction to a backhaul scheduler of a backhaul of the wireless network; and
coordinating the wireless scheduler with the backhaul scheduler by configuring the backhaul scheduler to coordinate transmission of the uplink data through the backhaul based on the uplink data prediction.

16. (canceled)

17. The system of claim 15, wherein the instructions which, when executed by the one or more processors, further cause the one or more processors to perform operations comprising identifying the uplink data prediction from downlink traffic transmitted through the wireless network over the wireless connection and the backhaul of the wireless network.

18. The system of claim 15, wherein the instructions which, when executed by the one or more processors, further cause the one or more processors to perform operations comprising identifying the uplink data prediction from traffic patterns of uplink data transmitted through the wireless network over the wireless connection and the backhaul of the wireless network.

19. The system of claim 18, wherein the instructions which, when executed by the one or more processors, further cause the one or more processors to perform operations comprising:
identifying an estimate of an accuracy of the uplink data prediction; and
providing the estimate of the accuracy of the uplink data prediction with the uplink data prediction to the backhaul scheduler to coordinate transmission of the uplink data through the backhaul based on the uplink data prediction and the accuracy of the uplink data prediction.

20. A non-transitory computer-readable storage medium having stored therein instructions which, when executed by a processor, cause the processor to perform operations comprising:
identifying, by a wireless scheduler of an IEEE 802.11ax compliant wireless network, an uplink data prediction for uplink data to transmit over a wireless connection of the wireless network, wherein the uplink data prediction is made before the uplink data is received at the backhaul and the uplink data prediction includes a prediction of at least one of an arrival time of the uplink data, an amount of traffic in the uplink data, quality of service requirements for the uplink data, a user associated with the uplink data, a traffic arrival rate of the uplink data, and a data type of the uplink data;
providing the uplink data prediction to a backhaul scheduler of a backhaul of the wireless network;
coordinating the wireless scheduler with the backhaul scheduler by configuring the backhaul scheduler to coordinate transmission of the uplink data through the backhaul based on the uplink data prediction; and
receiving the uplink data at the backhaul for transmission through the backhaul based on the uplink data prediction.

21. The system of claim 15, wherein the instructions which, when executed by the one or more processors, further cause the one or more processors to perform operations comprising generating, by the backhaul scheduler based on the uplink data prediction, an uplink grant for transmitting the uplink data through the backhaul.

22. The system of claim 21, wherein the uplink grant is generated before the uplink data is received at the backhaul.
